(19) United States
(12) Patent Application Publication
(10) Pub. No.: US 2007/0291957 A1
(43) Pub. Date: Dec. 20, 2007

(54) Sound system for motorcycles and similar vehicles

(76) Inventor: Farooq Ahmad Khan, Franklin Park, IL (US)

Correspondence Address: CHRISTOPHER D. HARRINGTON, SUITE 350, 5300 CORPORATE GROVE DRIVE SE, GRAND RAPIDS, MI, 49512, US

(21) Appl. No.: 11/454,958

(22) Filed: Jun. 19, 2006

(51) Int. Cl. H04B 1/00

(52) U.S. Cl. 381/86

(57) ABSTRACT

A novel sound system for use on a motorcycle or similar vehicle is disclosed as comprising a stereo housing, a power supply, a stereo source, mirror/speaker assemblies, a control that is remote from the stereo source, and a wiring harness for operational interconnection between the components. In use, the sound system is installable in a way to integrate with the architecture of the motorcycle and to preclude obstruction of the operator in the use of the motorcycle.

### RELATED APPLICATIONS

Not applicable.

### STATEMENT REGARDING GOVERNMENTALLY FUNDED WORK

Not applicable.

### BACKGROUND OF THE INVENTION

The present invention relates to a sound system that is installable on motorcycles, motorbikes, ATVs, and similar types of vehicles. More specifically, the present invention relates to a sound system that can be provided as original equipment from the manufacturer or as an aftermarket basis for installation on vehicles such as motorcycles and the like, the sound system including wireless controls to obviate the need for hard wiring.

Motorcycles and similar types of vehicles pose special challenges with respect to sound systems. Typically the sound system competes with the environment in which the vehicle is being used. At high rates of speed, certain weather conditions, engine noise, and similar circumstances, all affect the sound listening experience. Notwithstanding these drawbacks, the owners and users of motorcycles and similar vehicles find it very desirable to have sound systems even if the manufacturer is not so inclined to include this as an original equipment accessory.

Attempts have been made in the prior art to provide feasible sound systems for the owners and users of motorcycles. For instance, in U.S. Pat. No. 4,436,350 (Jolin) a housing containing a sound system is shown as mounting directly to the handlebars of a motorcycle. The system is self-contained in the housing and is not integrated with the architecture of the motorcycle. Similarly, in U.S. Pat. No. 4,754,901 (Villanueva, et al) a sound system is taught for use with bicycles, motorbikes and the like which also is packaged in a self-contained system that mounts to the handlebar area. In Villanueva the sound system is integrated within the architecture of the bike to a somewhat larger degree than is the case for Jolin above, but it still doe not provide an original equipment appearance and fit.

In U.S. Pat. No. 4,445,228 (Bruni) a sound system is supplied for a motorcycle that includes mirrors that have embedded speakers. Bruni still requires the main components of the sound system to be mounted in the area of the handlebars and they remain very obvious. Yet another example of a sound system that is a self-contained package that is mounted onto the handlebar area of a motorcycle or similar vehicle is shown in U.S. Pat. No. 5,771,305 (Davis) where a “bag stereo” is suspended from the handlebars. In U.S. Design Pat. No. D268,403 (Masterson) a design for a combined radio and speaker housing for use on a motorcycle is disclose, but again this unit appears to be related to a virtually self-contained system that is mounted in or around the handlebar area on the motorcycle.

Of some additional interest is the concept taught in U.S. Pat. No. 5,790,065 (Yaroch) which teaches a remote control for controlling an audio system in a motor vehicle which is hardwired to the receiver and which is integrated with the condition status of the ignition switch to provide differing selections and responses depending on the status of the motor vehicle.

None of the foregoing sound systems represents a significant solution to the problem of providing an original equipment appearance and fit for a sound system for a motorcycle or similar vehicle. In addition, the prior art depends largely upon the handlebar architecture of the motorcycle for suspension of the system, which are typically found as a complete system in one package. These approaches tend to be obstructive and one could even suggest they raise the real potential and concern for interference with the operator of the motorcycle. The prior art systems do not provide for convenient and ready access to controls either which is a major concern for operators of motorcycles who are more focused on retaining control over the steering of the vehicle than would be the case for a car or a truck. Many of the prior art systems are relatively exposed, not only to weather conditions but also to third parties who may seek to steal the components from the owner's motorcycle. The more the sound system can be integrated into the vehicle, therefore, the less likely it is to become the target of theft. These and other problems in the prior art merely point out the long-standing need for a solution to the problem of providing a sound system for a motorcycle that is efficiently oriented, minimally invasive and non-obstructive and that is highly integrated within the architecture of the vehicle.

It is asserted that the features and benefits of the present invention solves many, if not all of the foregoing observed problems in a way that has not been contemplated before now and beneficially allows for the after-market installation of a sound system onto a motorcycle or similar vehicle.

### SUMMARY OF THE INVENTION

A novel sound system for use on a motorcycle or similar type of vehicle, is comprised of a speakers integrally embedded in rear view mirror assemblies, a control that is mountable in an operator-friendly location, a stereo source, a power supply, output communications between the stereo source and the speakers, interactive communications between the control and the stereo source, and a housing for the stereo source that is mountable on remote locations on the vehicle. In use, the sound system allows the operator of the motorcycle to activate the stereo source and to select the desired material for playing, and to control the output from the stereo source to the speakers, all through the control.

In another embodiment of the present invention, the communications between the control and the stereo source is accomplished through wireless communications.

### BRIEF DESCRIPTION OF THE DRAWINGS

FIG. 1 is side view of a motorcycle (in phantom) showing an operator (in phantom) mounted on the vehicle, and with the sound system of the present invention shown.

FIG. 2 is a front view of the speaker/mirror assembly, the control, and the communications harness of the present invention as installed on a portion of the motorcycle (in phantom) of FIG. 1.

FIG. 3 is an isometric view of the stereo housing of the present invention, with a cutaway portion showing the stereo source in the interior of the stereo housing.

FIG. 4 is a side view of the stereo housing of FIG. 3.

FIG. 5 is a bottom view of the stereo housing of FIG. 3.

FIG. 6 is a side view of an alternate motorcycle type.

FIG. 7 is a side view of the motorcycle of FIG. 6 with an alternate sound system of the present invention installed.

FIG. 8 is a side of the motorcycle of FIG. 6 showing yet another alternate embodiment of the sound system installed.

### DETAILED DESCRIPTION OF THE PREFERRED EMBODIMENTS

A novel sound system for use on a motorcycle or similar vehicle is disclosed in the drawings and is discussed in more detail below. The present invention is directed towards use on a motorcycle but it is understood that it may be equally appropriate for use with minor modifications on motorbikes, bicycles, motor scooters, ATVs (all terrain vehicles) and similar types of vehicles. For the purposes of the discussion herein, the term motorcycle shall apply to all of the potential vehicles that are suited for the installation of the invention.

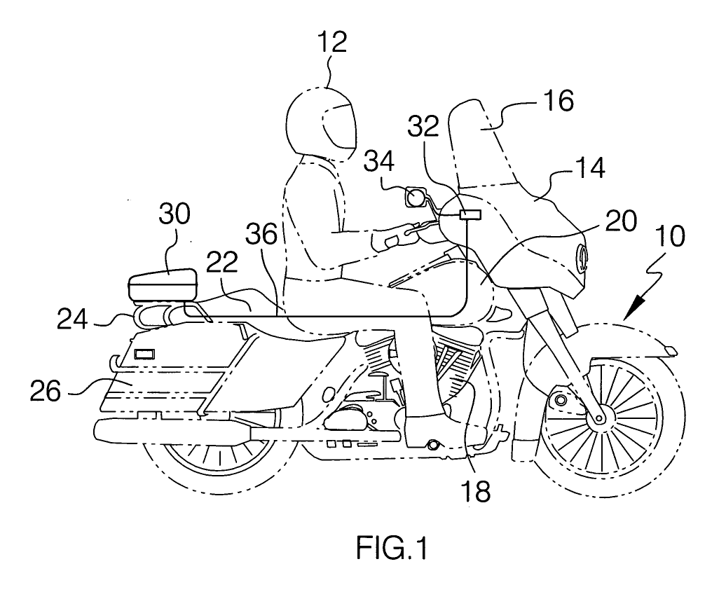

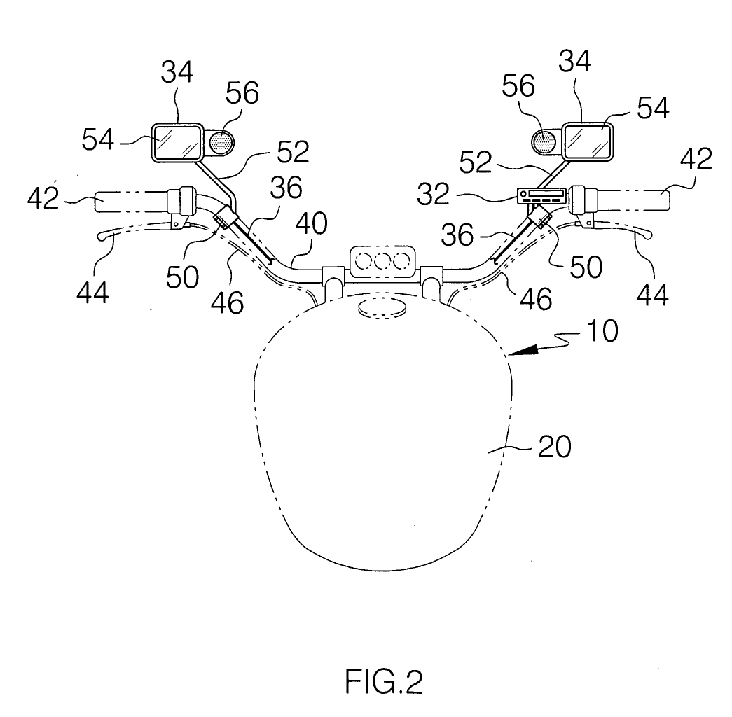

Turning now to FIG. 1, a motorcycle 10 is shown (in phantom) with an operator 12 (in phantom) and where the motorcycle 10 includes a faring 14, a windshield 16, an engine 18, a gas tank 20, a seat 22, a rack 24, and saddle bags 26. The sound system of the present invention is also shown and includes the stereo housing 30, the control 32, the mirror/speaker assembly 34 and the wiring harness 36. More details can be viewed in FIG. 2, with the motorcycle handlebars 40, the handles 42, the hand brakes 44, and the brake cable 46. The sound system components include the mirror/speaker mounts 50, the mirror/speaker supports 52, the mirror(s) 54 and the speaker(s) 56.

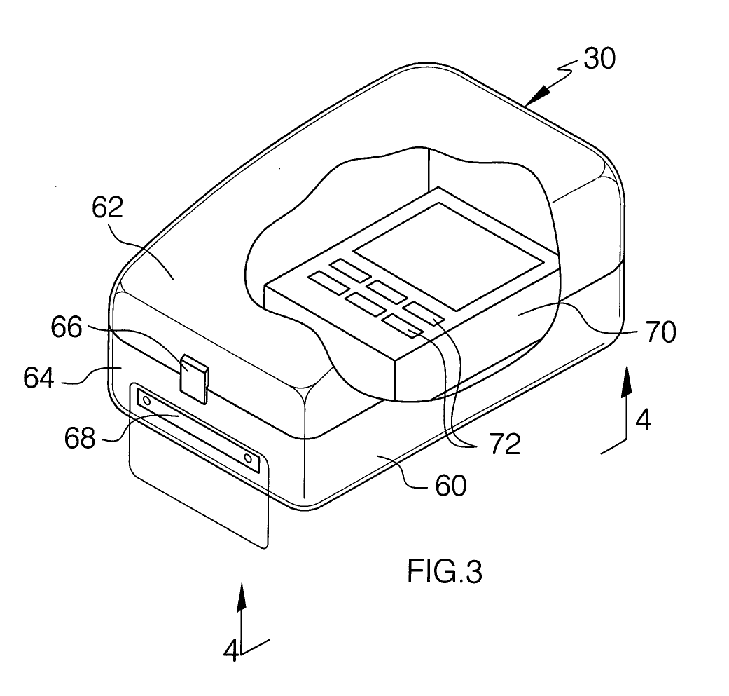

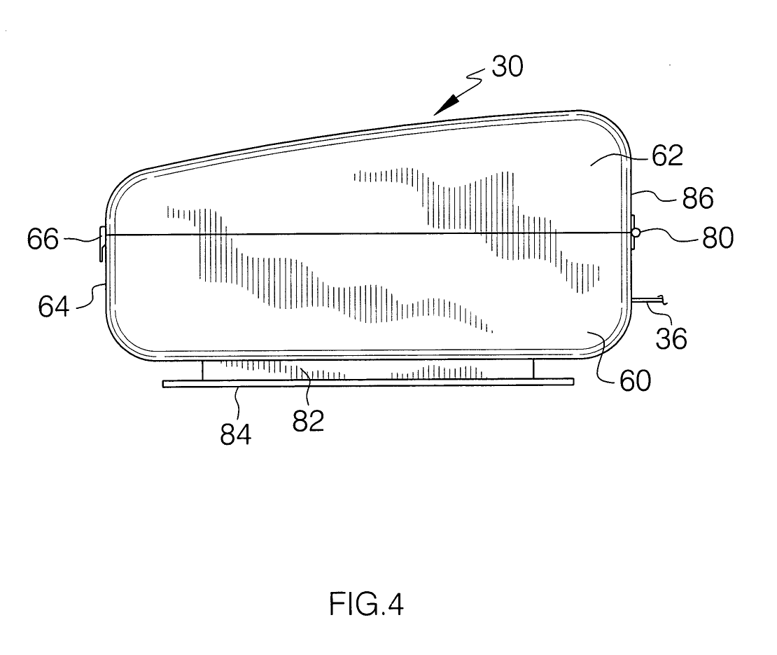

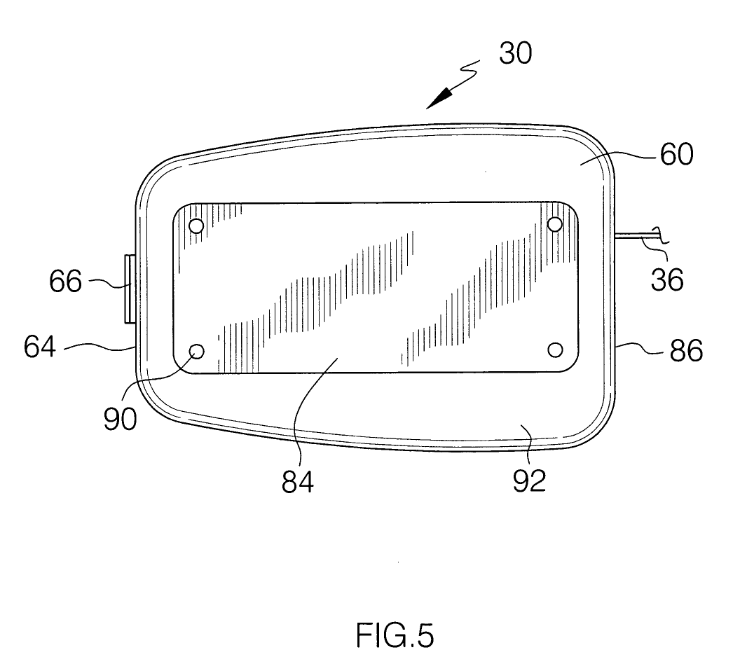

A portion of the sound system is shown in FIGS. 3, 4 and 5, commencing with the stereo housing 30, which includes a lower case 60, an upper case 62, a housing rear 64, a latch 66, and a license plate bracket 68. Interior of the housing is the stereo source 70 which includes the manual controls 72. Turning to FIG. 4, the stereo housing is shown with the hinge 80, the base 82, the housing mount 84 and the housing front 86. Finally, in FIG. 5 the stereo housing 30 is shown with the mounting holes 90 and the housing bottom 92.

In use, the components of the sound system are installed on the motorcycle 10 in a discrete manner and as will be seen, integrate within the natural architecture of vehicles such as motorcycles. In particular point, the stereo housing 30 is mountable at some point distant from the handlebars 40, the location shown in FIG. 1 being at the rear of the motorcycle 10, on top of a utility rack 24. The housing mount 84 offers the mounting holes 90 for use in securing the stereo housing 30 to the rack 24 or any other suitable location on the motorcycle 10. This allows the bulkiest components of the sound system to be kept out of the way of the operator 12 for both convenience and for safety reasons. As was seen in the drawings, the stereo source 70 is housed within the stereo housing 30 which is kept closed by the latch 66 which can be opened to allow the stereo housing 30 to be opened. The upper case 62 rotates about the hinge 80 allowing it to be lifted out of the way to gain access to the stereo source 70 which is mounted to the interior of the lower case 60. The stereo housing 30 could be locked, if desired, by adding a hasp or similar feature to the latch 66 which could then be secured using a padlock or similar type of locking mechanism.

The stereo housing 30 is typically made from a plastic or fiberglass, of sufficient type and thickness to provide strength and protection from impacts. It is also preferred that the plastic or fiberglass be selected or finished in a way to impart resistance to the elements or weather proofing, such that exposure to rain, wind, sun, and the like, will not appreciably affect the stereo housing 30 or its contents.

The mirror/speaker assemblies 34 are located on each of the handlebars 40. They are installed through the use of the mirror/speaker mounts 50 which compatibly attach to the handlebars 40 forming a solid anchoring point, from which the mirror/speaker supports 52 extend upwardly and hold the paired mirror 54 and speaker 56 components in an appropriate location. As it turns out, the location for mirror placement is very much compatible with the placement for speakers on a motorcycle when considering the projection of sound from the speakers 56 of the present invention.

In close association with the handles 42 on the handlebars 40, in particular one handle 42 as shown in FIG. 2, is the control 32. The control 32 is used by the operator 12 to activate the sound system and to adjust it to the desired positions. This would include all functions normally associated with sound system such as the ability to switch between devices, e.g., tape, CD, FM, AM, etc., and also to control volume, tonal quality, and balance parameters. The control 32 is beneficially placed near the handle 42 to allow ergonomic considerations in usage. The operator 12 does not have to reach to change any of the control settings, it is only a matter extending a thumb or finger to make such changes as are desired. This allows the operator 12 to maintain contact with the handlebars 40 at all times.

The control 32 is shown as diagrammatically being connected to the stereo housing 30 (and while not shown specifically it is understood to connect to the stereo source 70) by the wiring harness 36. This portrayal is described as being diagrammatical for the reason that a second embodiment of this connection will be discussed below and the representation in FIG. 1 is applicable to both versions of the present invention. As may be appreciated, the wiring harness 36 also extends to each of the mirror/speaker assemblies 34 as well. Interconnections are made between the components of the sound system through the wiring harness 36 in order to make the system work, which is conventionally understood in the art and does not specifically form a part of the present invention. Thus, when the installation is complete, the operator 12 is able to activate the sound system from the control 32, and to make the desired adjustments, with the result that music or other audible content issues from the speakers 56.

The sound system of the present invention requires a power supply which may be provided by a battery or it may take power from the electrical system (not shown) of the motorcycle 10. The latter option is preferred for the reason that it will ensure that the operation of the sound system will be ready at any time the motorcycle is used, rather than risk the loss of use due to a dead battery. In either event, the battery and the electrical system will be electrically connected to the stereo source 70 and this connection (not shown) forms part of the overall wiring harness 36. Such connections (battery and electrical power) are well known in the prior art and other than providing the stereo source 70 with power, they do not specifically form a part of the present invention with respect to the type and kind connections that are made. The stereo source 70 may comprise a conventional stereo sound system, purchased off the shelf, that is physically compatible with storage in the stereo housing 30 or it may comprise a custom stereo sound system that is designed for the present invention. The stereo source 70 would necessarily have to be compatible with wireless remote control if the control 32 were used in the installation otherwise the stereo source would have to be compatible with a hard wired remote control 32. The selection of the type of stereo functions to be provided by the sound system is entirely left to the owner of the motorcycle 10 and can certainly include the selection of a sound system with multiple functions.

The separation of the components of the sound system allows them to be located harmoniously within the architecture of the motorcycle 10. This reduces the clutter and obstruction that would otherwise exist in front of the operator 12 if the prior art devices are used. In addition, the present sound system is discrete, and is not so exposed as to draw the attention of persons who might try to steal the device from the vehicle. It should be understood that the wiring harness 36 is typically strung within the framework of the motorcycle 10 in a hidden manner to the extent possible or feasible. It is typically retained to prevent it from coming loose and interfering with the operation of the motorcycle 10.

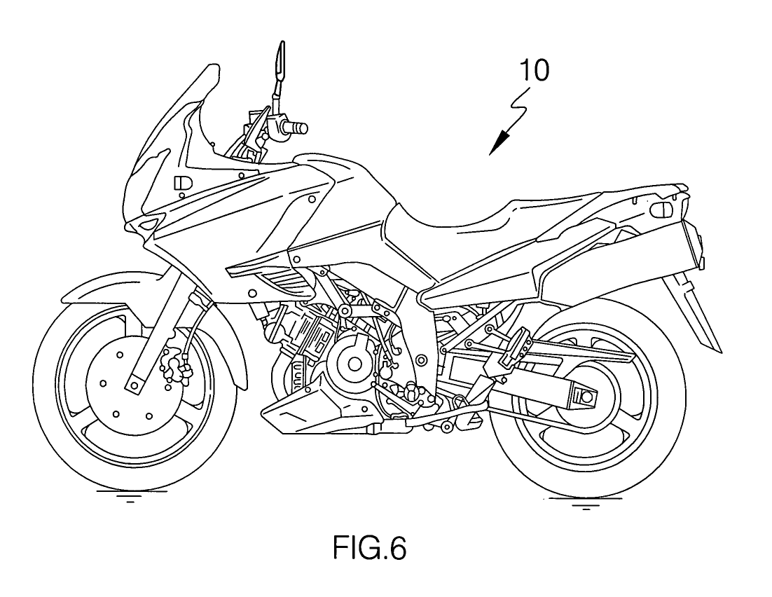

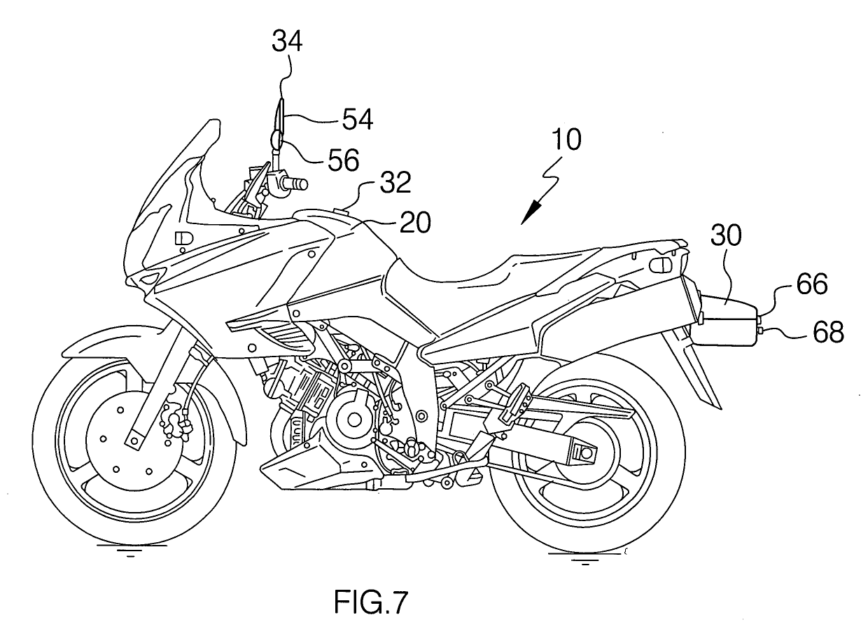

In FIGS. 6 and 7, an alternate type of motorcycle 10 is disclosed, and in FIG. 7 it is outfitted with a sound system of the present invention. Owing to the integration of the components, much of the sound system can be concealed, such as the wiring harness and the stereo source, and the like, thus presenting a neat and original equipment like appearance. Turning to FIG. 7, the components that are revealed include the mirror/speaker assembly 34, the control 32, and the stereo housing 30. The mirror/speaker assembly 34 is shown in this case with the mirror portion 54 on the top of the assembly and the speaker 56 on the lower part of the assembly. This configuration may be less distracting to the operator of the motorcycle 10 than where the two components are located side-by-side.

Also viewable in FIG. 7 are the latch 66 and the license plate bracket 68. The stereo housing 30 works in the same manner as in the previous embodiment although it is now located in a different position. In this instance, the stereo housing 30 is fitted to the existing license plate bracket (not shown) that was provided on the motorcycle 10 which represents a near universal mounting approach for the stereo housing 30. As can be seen the housing base and the housing mount previously found on the stereo housing 30 are eliminated in this instance and a two-hole or four-hole mounting can be made directly to the existing license plate bracket through the housing rear 64.

With respect to the control 32, it is shown as being adhered to the side of the motorcycle 10. In this embodiment, the control 32 may be of a wireless type, or it can be hardwired, the hard wired version being preferred since it is a more robust and durable control. If the control is wireless, it will typically include a battery to power it independently. No part of the wiring harness is necessary for connection to the control 32 in the wireless embodiment since it will operate directly with the stereo source through wireless communication. The usage of a wireless control 32 allows the placement of the unit to be made virtually anywhere it may be considered on the motorcycle 10. For the same reasons that were suggested above, placement is usually preferred to be in close relation to the operator who will be using it for ease of use when making adjustments to the sound system. Being wireless, the control 32 can merely be mounted in place, without more, which not only increases the ease of installation but it provides a cosmetically superior result.

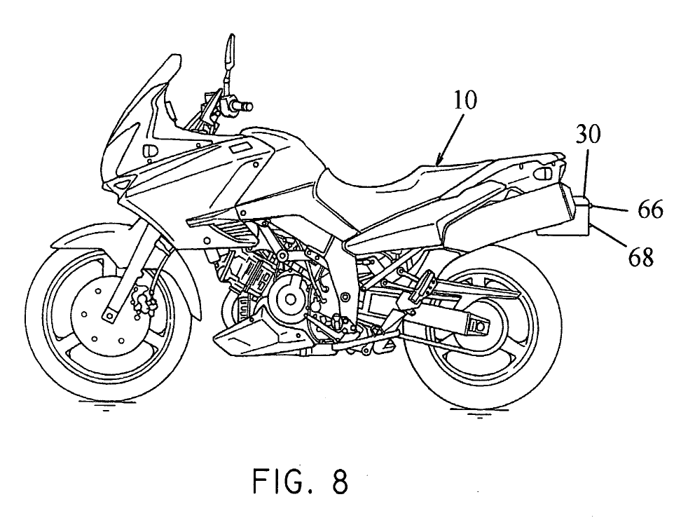

Turning now to FIG. 8, the motorcycle 10 of FIGS. 6 and 7 is shown, however in this instance, the stereo housing 30 is fitted where the rear fender of the motorcycle 10 used to be. The rear fender is removed to allow the stereo housing 30 of the present invention to be tucked into the same space and this provides an additional aerodynamic effect. In addition, the speakers 56 are located within the cowling of the motorcycle 10 in this embodiment which achieves the same purposes and effects of the previous embodiments as far as convenience and safety. Lastly, the control 32 is shown as being affixed to the faring of the motorcycle 10, which is one example of the varied locations that the control 32, whether it is hard wired or wireless, may be located.

The sound system of the present invention may be supplied as an original equipment item if it were so desired by the manufacturer of the motorcycle, however in most cases it is anticipated that the use of the present invention will be to provide a sound system to a motorcycle that was never outfitted with one originally. The components of the sound system can therefore be supplied in kit form, with appropriate instructions for installation, and it is believed that the ability to complete this type of project would be well within the skill set of most people. Thus the owner of the motorcycle will end up with a sound system that looks to be original equipment and that won't detract from the cosmetics of the motorcycle.

Other variations and modifications of the present invention can be made without departing from the spirit and scope of the concepts taught herein. The examples and illustrations provided above are meant to assist one in understanding the benefits of the present invention and are not meant to be limiting in any way.

I claim:

1. A sound system for use on a motorcycle or similar vehicle by the operator of the motorcycle or other such vehicle, the sound system comprising:
A power supply;
A portable stereo source;
A housing with a lower case and an upper case where lower case and the upper case are hinged together at one end, for enclosing said stereo source, the housing being mountable onto the motorcycle;
At least one speaker located in close association with a rear view mirror of the motorcycle;
A wiring harness for electrically operable connection between the power supply, the stereo source, and the speaker(s); and,
A control for communication with the stereo source and for controllably operating the sound system from a remote location.

2. The sound system of claim Number 1, where the sound system includes at least a pair of speakers.

3. The sound system of claim number 2, where each of said speakers is configured with a rear view mirror to form a mirror/speaker assembly.

4. The sound system of claim Number 1, where the housing is of weatherproof construction.

5. The sound system of claim Number 1, where said control is ergonomically located to reduce the difficult of accessing the control by the operator while he/she is driving.

6. The sound system of claim number 3, where the sound system is comprised of a pair of mirror/speaker assemblies, and where in each of said mirror/speaker assembly the speaker portion is located below the mirror portion.

7. A sound system for original equipment or after-market installation, for use on a motorcycle or similar vehicle by the operator of the motorcycle or other such vehicle, the sound system comprising:
A power supply;
A stereo source with the capacity for remote control communication;
A housing with a lower case and an upper case and where the lower case and the upper case are hinged together at one end, for enclosing said stereo source, the housing being mountable onto the motorcycle;
At least two speakers, each of said speakers located in close association with the operator of the motorcycle;
A wiring harness for electrically operable connection between the power supply, the stereo source, and the speaker(s); and,
A control capable of communication with the stereo source and for controllably operating the sound system from a remote location.

8. The sound system of claim Number 7, where the remotely located control is hard wired to the stereo source.

9. The sound system of claim Number 7, where the control and the stereo source are in wireless communication.

10. The sound system of claim Number 7, where said control is ergonomically located to reduce the difficult of accessing the control by the operator while he/she is driving.

11. The sound system of claim Number 7, where the housing is of weatherproof construction.

12. The sound system of claim Number 7, where the housing is mounted on the rear portion of the motorcycle.

13. The sound system of claim Number 12, where the housing is mountable to the existing license plate bracket of the motorcycle and where said housing includes a license plate bracket for the display of a license plate.

14. A sound system for original equipment and/or after-market installation, for use on a motorcycle or similar vehicle by the operator of the motorcycle or other such vehicle, the sound system comprising:
A power supply;
A stereo source with the capacity for remote control communication;
A housing mountable onto a motorcycle and suitable for enclosing said stereo source, with a lower case and an upper case and where the housing has a front end and a rear end, where the lower case and the upper case are hinged together at the rear end, and where the housing is mountable to the existing license plate bracket of the motorcycle and where said housing includes a license plate bracket at the front end for the display of a license plate;
At least two speakers, each of said speakers located in close association with the operator of the motorcycle and located to minimally obstruct the visibility of the operator;
A wiring harness for electrically operable connection between the power supply, the stereo source, and the speaker(s); and,
A control capable of communication with the stereo source and for controllably operating the sound system from a remote location.

15. The sound system of claim Number 14, where the housing is of weatherproof construction.

16. The sound system of claim Number 14, where the control and the stereo source are in wireless communication.

17. The sound system of claim Number 14, where the remotely located control is hard wired to the stereo source.

18. The sound system of claim Number 14, where said control is ergonomically located to reduce the difficult of accessing the control by the operator while he/she is driving.
